(19) United States
(12) Patent Application Publication
(10) Pub. No.: US 2009/0204664 A1
(43) Pub. Date: Aug. 13, 2009

(54) DYNAMIC ATTACHMENT OF ADVERTISING TO DOWNLOADED CONTENT

(75) Inventors: John Andre Yovin, Woodinville, WA (US); Praful Pratap Chavda, Redmond, WA (US); Richard E. Doherty, Northridge, CA (US); James C. Finger, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/029,476

(22) Filed: Feb. 12, 2008

(51) Int. Cl. G06F 15/16

(52) U.S. Cl. 709/203

(57) ABSTRACT

Arrangements are provided for dynamically attaching advertisements to requested and downloaded content items. The advertisements or other content are combined with the requested and downloaded content item so that future playback of the content item also includes playback of the advertisement. The attachment may be performed at the time that the content item is requested, or the advertisement may be retrieved over a network at the time the requested content item is played back. The content may also be local to the client, e.g., downloaded content or content from an HD-DVD, and the same may instigate the playing of a downloaded advertisement at the time of downloading, loading, or playback. In any case, the advertisement may be played back before, during or after the playback of the requested content item. The combining of the advertisement with the requested content item may occur at the server-side or at the client side.

### BACKGROUND

Advertising on the internet is ubiquitous and many revenue models are built around the same. It is thus important that advertising reaches the consumers to which it is intended.

In many cases, however, this goal is not met by current arrangements. For example, live advertisements, which work for streamed media or web pages, may not provide a desired level of control or variability for downloaded content, as downloaded content may be referenced or played back at any point in the future, including well after it was downloaded.

Advertising content has also been embedded into content prior to a download request, e.g., advertisements have been placed at the beginning of a Windows® Media File which is downloaded to users upon request. In this case, all individuals who download the file receive the same advertisement, and when new advertisements are made available, or old ones are no longer valid, downloadable content has to be altered accordingly. Thus, this solution also does not satisfactorily meet the goal.

### SUMMARY

The arrangements described here provide for dynamic attachment of advertisements or other content to requested and downloaded content items. The advertisement is combined with the requested and downloaded content item so that future playback of the content item also includes playback of the advertisement.

In one arrangement, dynamic attachment of an advertisement to a requested content item is performed at the time that the content item is requested. In another arrangement, a dynamic attachment of an advertisement is performed that allows download of a requested content item and then subsequent retrieval of live data corresponding to the advertisement over a network at the time the requested content item is played back. In a further arrangement, the content may be local to the client, e.g., content from an HD-DVD or a media file (which may itself have been previously downloaded), and the same may instigate the playing of an advertisement, either downloaded or streamed at the time of content playback or alternatively pre-downloaded and subsequently played back at the time of content playback.

In any case, the advertisement may be played back before, during or after the playback of the requested content item. The combining of the advertisement with the requested content item may occur at the server-side or at the client side.

Using this arrangement, potential advertisements (or other content) may be added or removed as the requested content is delivered, while the original requested content is desirably unaltered. Moreover, the arrangement allows for a different way to target advertisements, i.e., the advertisement is viewed at the time the content is viewed rather than when it is acquired, as is the case for web banners and other forms of web site advertisement. For situations where the paradigm of “download-once-view-many-times” is employed, the arrangement allows for enhanced coverage and display of the advertisement. The arrangement may also help address the problem of sites linking directly to a content item on another site, this linking often being associated with attempts to circumvent the viewing of the advertisement. In addition, the arrangement may allow that the advertisement may be chosen from a pool of potential advertisements rather than a fixed advertisement that is pre-combined with a content item.

This Summary is provided to introduce a selection of concepts in a simplified form. The concepts are further described in the Detailed Description section. Elements or steps other than those described in this Summary are possible, and no element or step is necessarily required. This Summary is not intended to identify key features or essential features of the claimed subject matter, nor is it intended for use as an aid in determining the scope of the claimed subject matter. The claimed subject matter is not limited to implementations that solve any or all disadvantages noted in any part of this disclosure.

### BRIEF DESCRIPTION OF THE FIGURES

FIG. 1 illustrates a first exemplary schematic arrangement for dynamically attaching advertisements to content items.

FIG. 2 shows exemplary file structures illustrating a dynamic attachment of an advertisement to a content item.

FIG. 3 is a flowchart demonstrating a method that may be employed by the arrangement of FIG. 1.

FIG. 4 illustrates a second exemplary schematic arrangement for dynamically attaching advertisements to content items.

FIG. 5 is a flowchart demonstrating a method that may be employed by the arrangement of FIG. 4.

FIG. 6 illustrates a third exemplary schematic arrangement for dynamically attaching advertisements to content items.

FIG. 7 is a flowchart demonstrating a method that may be employed by the arrangement of FIG. 6.

FIG. 8 shows exemplary code illustrating a dynamic attachment of an advertisement (as an executable content item) to a requested content item.

FIG. 9 is a simplified functional block diagram of an exemplary configuration of an operating environment in which the dynamic advertisement attachment arrangement may be implemented or used.

### DETAILED DESCRIPTION

Arrangements are described below to conveniently and dynamically combine advertisements or other content with requested content items. The following definitions are used in this description.

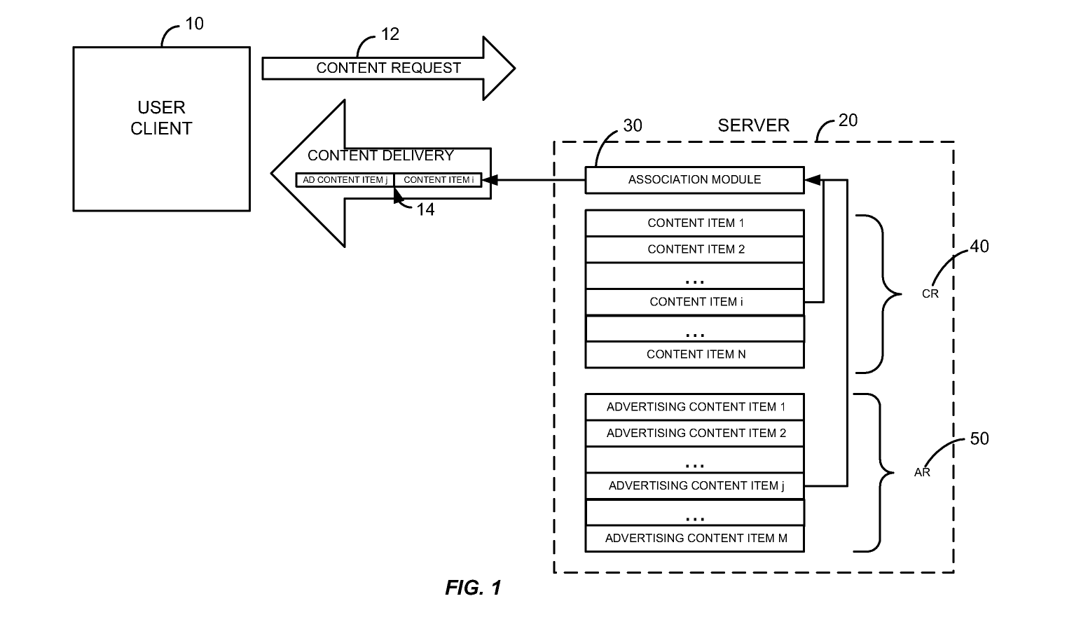

“Content items”, “items of content”, or just “content” (e.g., elements in repository 40 of FIG. 1) are blocks of data corresponding to music, movies, television shows, pictures, video clips, games, ringtones, etc. In particular, the terms represent any commercial or non-commercial stored digital content. Examples include but are not limited to digital media content (such as audio files, video files, image files, multimedia files, podcasts, and playlists), documents, spreadsheets, consumer transaction data, digital payment instruments, user profiles, contacts, metadata, digital licenses, and the like. Content items may exist in any known or later developed format or combination thereof, and may be protected by one or more enforceable intellectual property rights of one or more third parties, such as copyrights, patent rights, trademark rights, or trade secret rights. Content items may include executable files, multimedia content, advanced interactivity applications (such as HDi), etc. The parts of content may be split among files, or be segments of files. In the case of streaming content, it may not be a traditional file at all.

A “first content item” generally refers to a content item that is requested by a user. A “second content item” generally refers to a content item that is associated with the first content item and is arranged such that when the first content item is played back, the second content item is played back before, during, or after playback of the first content item. When played back before or after, the playback generally occurs just prior or just subsequent to playback of the first content item. The second content item may be, e.g., an advertisement, which is also termed here an advertising content item.

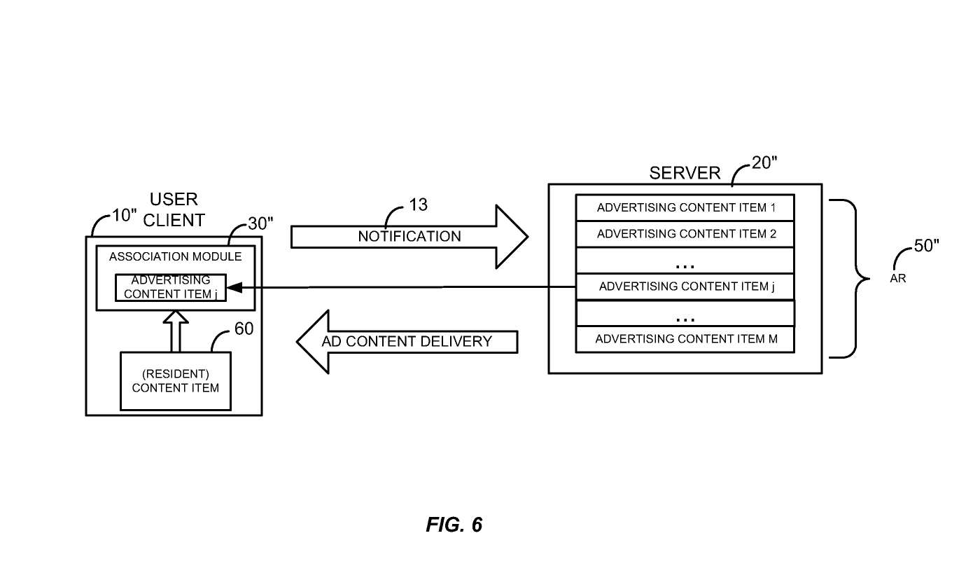

A “notification” (e.g., element 13 of FIG. 6) refers to a signal sent by a client to a server that a subject content item has been downloaded, loaded into, or played back by a player. For example, a notification may be sent if a subject DVD has been loaded into a DVD player. As another example, a notification may be sent if a subject media file has been downloaded by a client or loaded into a media player. As another example, a notification may be sent if a client performs a certain action on the downloaded content, such as initiating playback.

An “association module” (e.g., element 30 of FIG. 1) is a module that combines a first content item with a second content item, e.g., a module that combines an advertisement with a requested content item. An association module may be implemented in hardware, software, firmware, or any other such media, and may be implemented on a client side or on a server side. Additionally, the association module may be executed at download time, or any other point up to and including the time the content is accessed for playback. Moreover, a single association module may be implemented across multiple platforms or computing devices.

A “content repository” or the like (e.g., element 40 of FIG. 1) refers to a collection of content items which is connected to a network and which may be used as a source of content items. In many cases, the content repository is an internet storefront from which is downloaded music, videos, television shows, podcasts, video games, or other digital content items. In some cases, a content repository may have just one item within.

An “advertisement content item repository” or the like (e.g., element 50 of FIG. 1) refers to a collection of additional content items which is connected to a network and which may be used to download content items in addition to those in the content repository. In many cases, the additional content pertains to advertisements. In many cases, the advertisement content item repository is an internet storefront from which is downloaded additional music, videos, television shows, podcasts, video games, or other digital content items. In a way analogous to the content repository, the advertisement content item repository may in some cases only contain one advertisement.

“Signal communication” refers to the transmission of a signal from one point in a network or computing device to another point. For example, if a signal sent from one point is received at another, and vice-versa, those two points may be said to be signal communication with each other.

A “network” is a group of computers and associated devices that are connected by communications facilities, including those employing wired, wireless, or optical communications schemes. A network can involve permanent connections, such as cables, or temporary connections made through telephone or other communications links. A network can be as small as a local area network consisting of a few computers, or it can consist of many small and large computers distributed over a vast geographic network (e.g., a WAN). In this description, a network can include the Internet, WLANs, etc.

A “player” refers to a program that plays music, video, or other digital content items. Such content items are often encoded in a playable format, such as .mp3, .wmv, and the like. A player may in some cases include hardware components, such as in the case of a CD or DVD player.

To “stream” means to transfer data in a flow that is or appears to be continuous. Consumers often employ streaming techniques with respect to Internet transfers of files to enable large multimedia files to be accessed and displayed prior to completion of all data transfers. It is understood in this context that a certain amount of buffering may happen within the streaming context.

To “download” means to transfer a copy of a file from a remote computer to a requesting computer by means of a network or modem.

Referring to FIG. 1, a schematic arrangement is shown for dynamically attaching, appending, or combining advertisements to requested content items. A user client 10 sends a request 12 for a first content item. The request 12 is transmitted to and received by a server 20. The server 20 includes an association module 30, a content repository 40, and an advertising content item repository 50. A dotted line is shown for server 20 to indicate that the items within, i.e., the association module 30, the content repository 40, and the advertising content item repository 50, may be located on any number of physical computing devices, and the same may be geographically localized or geographically spread over any distances. The items within are generally within signal communication of each other.

The content item repository 40 is generally a collection of content items, such as may be available in an online store or other website. The content item repository 40 is shown with content item 1, content item 2, . . . , content item i, . . . , up to content item N. In some cases, however, the content item repository 40 may also contain only one content item or even no content items within. The content item repository 40 generally allows download of content items stored within. Fees may be charged for some downloads, and the same may incorporate appropriate protections for digital rights management.

The advertising content item repository 50 is generally a collection of advertising content items, and is shown in FIG. 1 with advertising content item 1, advertising content item 2, . . . , advertising content item j, . . . , up to advertising content item N. As with the content repository, in some cases, the advertising content item repository 50 may contain only one advertising content item or even no advertising content items within. The advertising content item repository 50 may be stored in one or more locations, and may be a small collection of advertisments on a single computer or a large collection of advertisements spread over several servers or over an entire network.

The association module 30 appends, attaches, or otherwise combines the requested content item with an advertising content item. For example, the association module 30 may append the advertising content item to the beginning or the end of the requested content item, or may insert the same at a point within the requested content item. The association module 30 may also reformat either the requested content item or the advertising content item to match the format of the other. This step of reformatting may also occur at either the content item repository 40 or the advertising content item repository 50, depending on which content item is the subject of the reformatting. The association module 30 may, in addition, append more than one advertising content item to a requested content item. For example, one may be be appended to the beginning of the requested content item and another to the end of the requested content item.

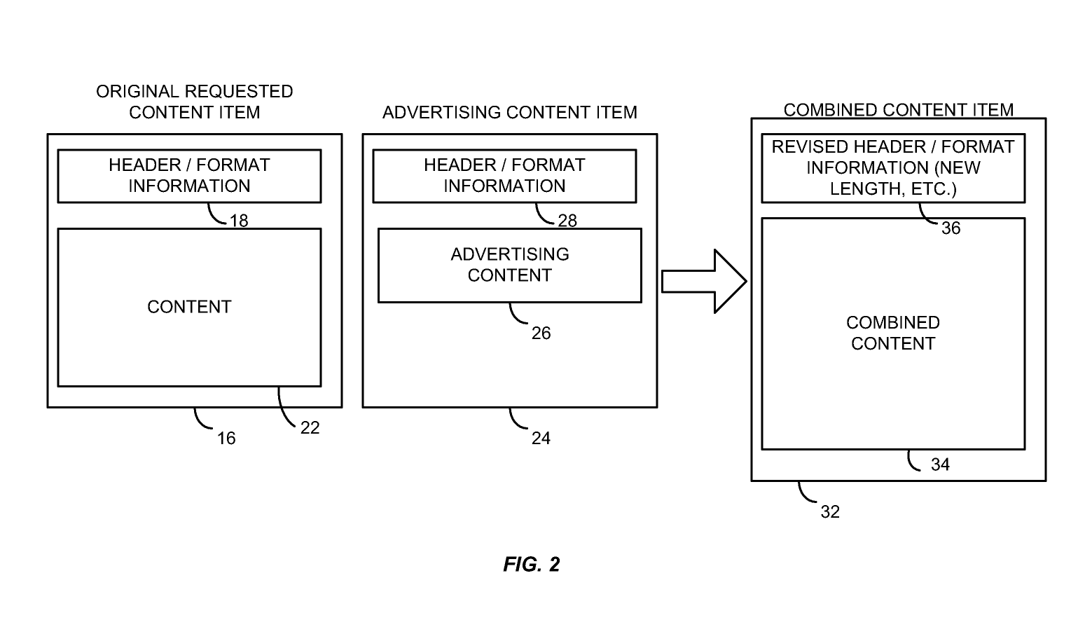

Once the association module performs the combination step, the combined item 14 may be downloaded to the client 10. In FIG. 1, the association module 30 has combined content item i with advertising content item j to obtain combined item 14. FIG. 2 shows this aspect in additional detail. Referring to that figure, an original requested content item 16 is shown having content 22 and header and format information 18. An advertising content item 24 is shown with advertising content 26 and with its own header and format information 28. The association module combines the requested content item 16 and the advertising content item 24, resulting in a combined content item 32 having combined content 34 and a revised header and format information 36. The revised header and format information 36 may include, e.g., a revised length to reflect the combined content.

The way in which the combining is performed may depend on the format of the content. For example, audio or video files may require encoding and merging. Executable files may require a wrapper for the entrypoint. A Word® document may simply require embedding of Word® formatted text. Certain forms of graphical advertising may require video composing or overlay.

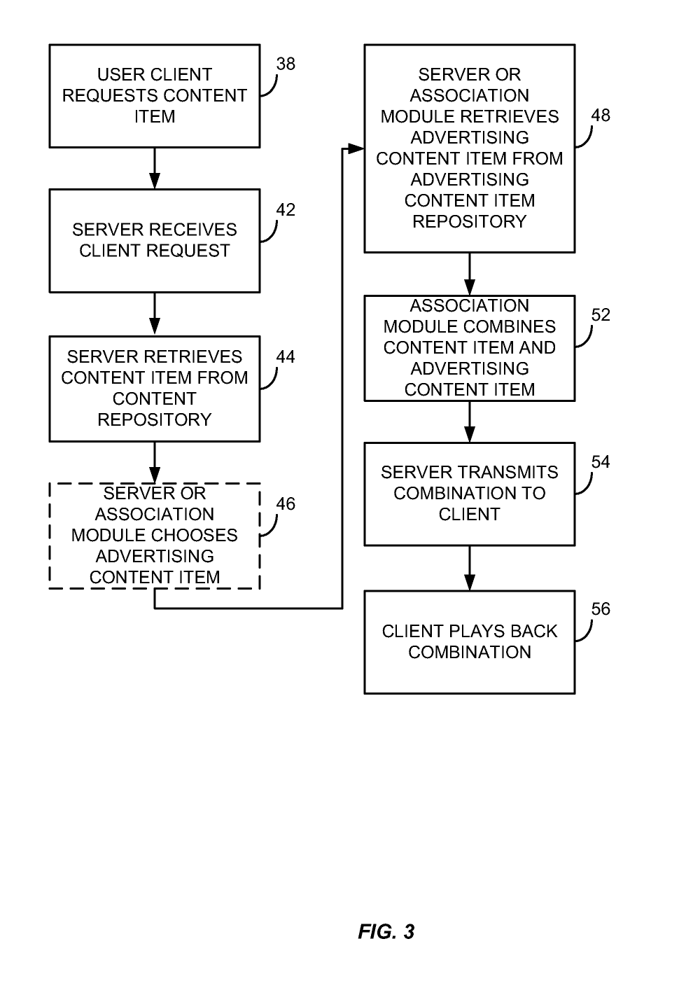

FIG. 3 illustrates an exemplary flowchart for the arrangement of FIG. 1. A user at a client system, e.g., client 10, requests a content item from a repository of such items, such as an online store or file-sharing site (step 38). A server receives this client request (step 42). The server retrieves the content item from the content repository (step 44). Prior to, contemporaneous with, or subsequent to the retrieval, the user may purchase or make any other arrangements for acquiring any necessary rights to the content item.

The server, an association module, an advertising content item repository, or any other such module or combination of such modules may then take the optional step of choosing an advertising content item to be combined and delivered for playback with the requested content item (step 46). Any of the arrangements described here or below may be employed, as well as other such arrangements. For example, client-side logic or any other known user preferences may be employed to determine which advertisement or other such content item should be combined with the requested content item. Alternatively, the advertisements may be chosen on the basis of business rules set up by the advertising server (based on contractual agreements), or the advertisements may be chosen randomly or on the basis of a list of advertisements that are delivered one after the next.

Once chosen or otherwise selected or identified, the advertising content item is retrieved if necessary from an advertising content item repository (step 48). The association module combines the content item with the advertising content item (step 52). The server transmits, downloads, or otherwise delivers the combined content item to the client (step 54). The server in this case may include the association module or a subsequent module that has received the combined content item and which then retransmits the same. After download, the client may then play back the combination (step 56). As noted below, download need not be completed prior to playback—the two may overlap in time.

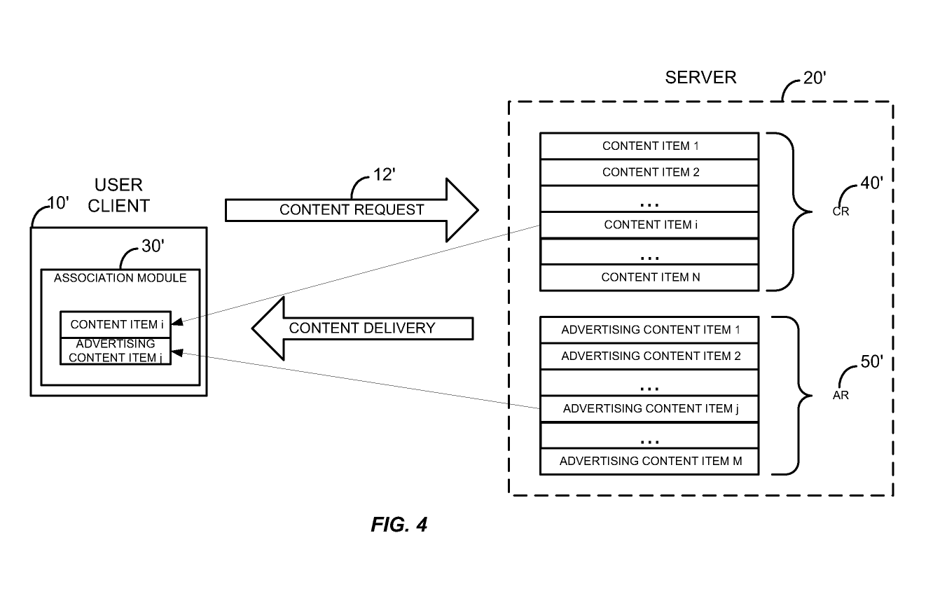

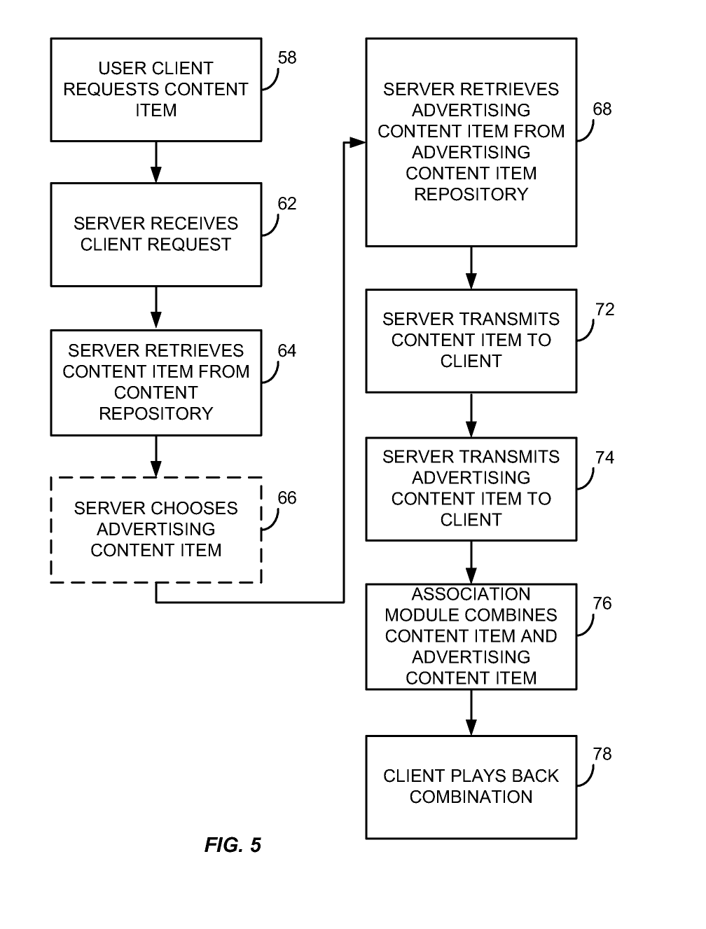

FIG. 4 shows an alternative arrangement for dynamically attaching, appending, or combining advertisements with requested content items. In particular, FIGS. 4 and 5 show the case where the advertisement is attached at the client. In this arrangement, a user client 10′ is shown that incorporates an association module 30′. In one exemplary arrangement, the association module 30′ is implemented employing HDi extensions technology.

The client 10′ transmits a request for content 12′ to a server 20′. The server 20′ is shown in dotted lines for the same reason as above, and the server 20′ incorporates or is in signal communication with a content item repository 40′ and an advertising content item repository 50′ which are similar to those described above. The server 20′ receives the request 12′ and directs the content item repository 40′ to send the requested content item (in FIG. 4, content item i) to the client 10′. The server 20′ also directs the advertising content item repository 50′ to send an advertising content item (in FIG. 4, advertising content item j) to the client 10′. Depending on the setup and arrangement of the content item repository 40′ and the advertising content item repository 50′, the same may send their respective content items directly to the client 10′ or via an intermediate process, such as via the server 20′.

The association module 30′ receives and combines the content item i and the advertising content item j, performs any reformatting if necessary, and, when directed, plays the combined content item back in a player.

FIG. 5 illustrates an exemplary flowchart for the arrangement of FIG. 4. A user at a client system, e.g., client 10′, requests a content item from a repository of such items, such as an online store or file-sharing site (step 58). A server receives this client request (step 62). The server retrieves the content item from the content repository (step 64). The discussion above with respect to FIG. 3 regarding purchasing or digital rights management similarly applies to this figure.

As in FIG. 3, the server or other such module may take the optional step of choosing an advertising content item to be combined and delivered for playback with the requested content item (step 66).

Once chosen or otherwise selected or identified, the advertising content item is retrieved if necessary from an advertising content item repository (step 68). The server (or content repository) then transmits, downloads, or otherwise delivers the requested content item to the client (step 72). The server (or advertising content item repository) then transmits, downloads, or otherwise delivers an advertising content item to the client (step 74).

The association module, resident on the client, combines the content item with the advertising content item (step 76). The client may then play back the combination (step 78).

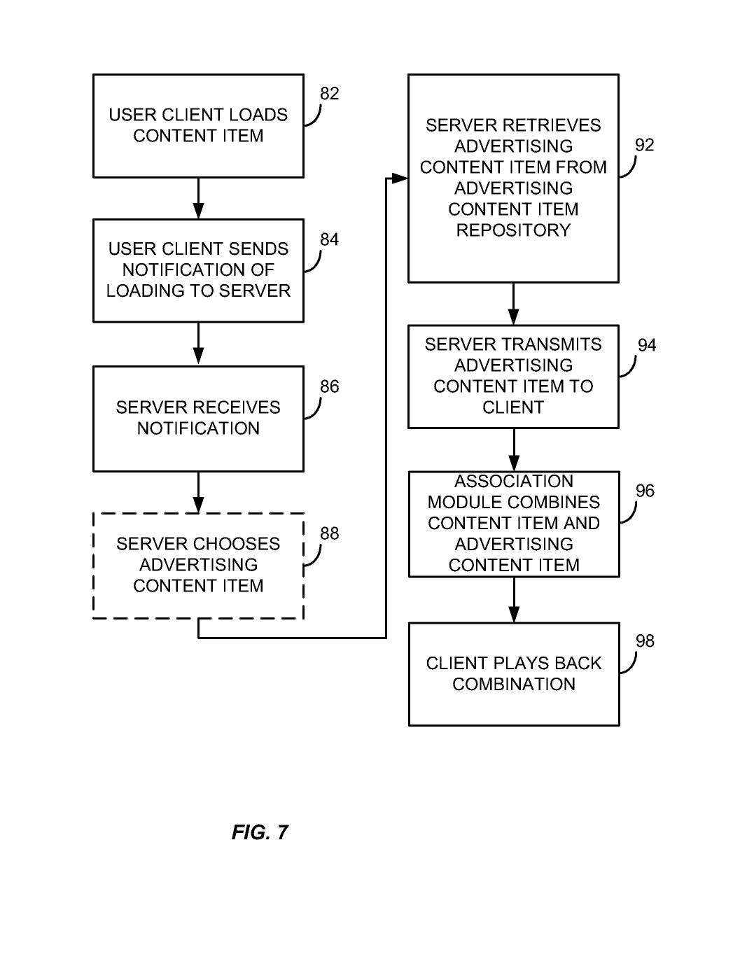

FIG. 6 shows an alternative arrangement for dynamically attaching, appending, or combining advertisements with requested content items. In particular, FIGS. 6-7 show the case where the advertisement is attached at the client to a pre-loaded content item. The pre-loaded content item may be either a media item such as a DVD or CD, or the like, or may be a pre-downloaded file whose download was the instigator for the notification to be sent.

In this arrangement, a user client 10″ is shown that, like FIG. 5, incorporates an association module 30″. The user client is shown with a content item 60 disposed therein. The content item 60 may be a previously-downloaded content item, or may be a content item such as a DVD, CD, or other media file. Upon loading or initiating playback of the content item 60, the client 10″ sends a notification 13 to a server 20″.

It is noted that if the content item 60 is a media file that has previously been downloaded, the client 10″ may also send a notification 13 to the server 20″ upon any of the following conditions: downloading of the content item 60, loading of the content item 60 into a player, or playback of the content item 60. For example, upon downloading the content item 60, the downloading may instigate downloading of an advertising content item in the manner described below. The content item 60 and the advertising content item may be combined in the background, e.g., by the association module, and both may be displayed once the combined content item is played back.

In any case, the server 20″ is shown in dotted lines for the same reason as above, and the server 20″ incorporates or is in signal communication with an advertising content item repository 50″ which are similar to those described above. The notification 13 causes the server 20″ to direct the advertising content item repository 50″ to send an advertising content item (in FIG. 6, advertising content item j) to the client 10″. In some arrangements, the advertising content item repository 50″ may send the advertising content item j directly to client 10″. The association module 30″ combines the content item 60 and the advertising content item j and, when directed, plays the combined content item back in a player.

It is noted in connection with this arrangement, and with any others, that a set of advertisements may be transferred in a batch, such as on a periodic or other basis. For example, a set of advertisements may be transferred once a day, once a week, and so on. Subsequently, when playback is started, there is no need to contact the server for advertisements; instead, one of the cached advertisements may be employed. Such an alternative arrangement may be particularly useful when the user's network connection is intermittent.

FIG. 7 illustrates an exemplary flowchart for the arrangement of FIG. 6. A user at a client system, e.g., client 10″, loads (or alternatively plays back) a content item (step 82). The client automatically or upon user consent sends a notification of the loading (or playing back) to a server (step 84). The server receives the notification (step 86).

As in FIGS. 3 or 5, the server or other such module may then take the optional step of choosing an advertising content item to be delivered for playback with the requested content item (step 88). And as above, the choosing may be highly personalized or, at the other extreme, simply random.

Once chosen or otherwise selected or identified, the advertising content item is retrieved if necessary from an advertising content item repository (step 92). The server (or advertising content item repository) then transmits, downloads, or otherwise delivers the advertising content item to the client (step 94).

The association module 30″, resident on the client 10″, combines the content item 60 with the advertising content item (step 96). The client may then play back the combination (step 98).

The above description is further explained below by reference to the following non-limiting examples.

### EXAMPLE 1

A user requests a downloadable multimedia object that is a .wmv file. Before sending the object to the user, the server side selects an advertisement in the form of a multimedia object. This object is merged into the .wmv file so that the downloaded file now contains an advertisement which is attached only after the request is made.

The attached file may be a .wmv file with similar properties, or optionally a different format which is converted and attached to the beginning, end, or at a middle point of the desired content. If a different format, the advertisement may be converted in format so that it matches that of the requested content. When the user watches the downloaded file, whether immediately or at a later time, the advertisement will be viewed as well. Because the content is added to the requested file, any client application later employed to view the content will also display the chosen advertisement.

### EXAMPLE 2

A situation similar to Example 1 may occur, except that instead of the advertisement, or in addition thereto, a tag is inserted into the content which directs the client application to attempt to retrieve new advertising content when referenced. A default may still be that the original advertisement is played back, especially if no new advertising content is available or if the client is offline.

### EXAMPLE 3

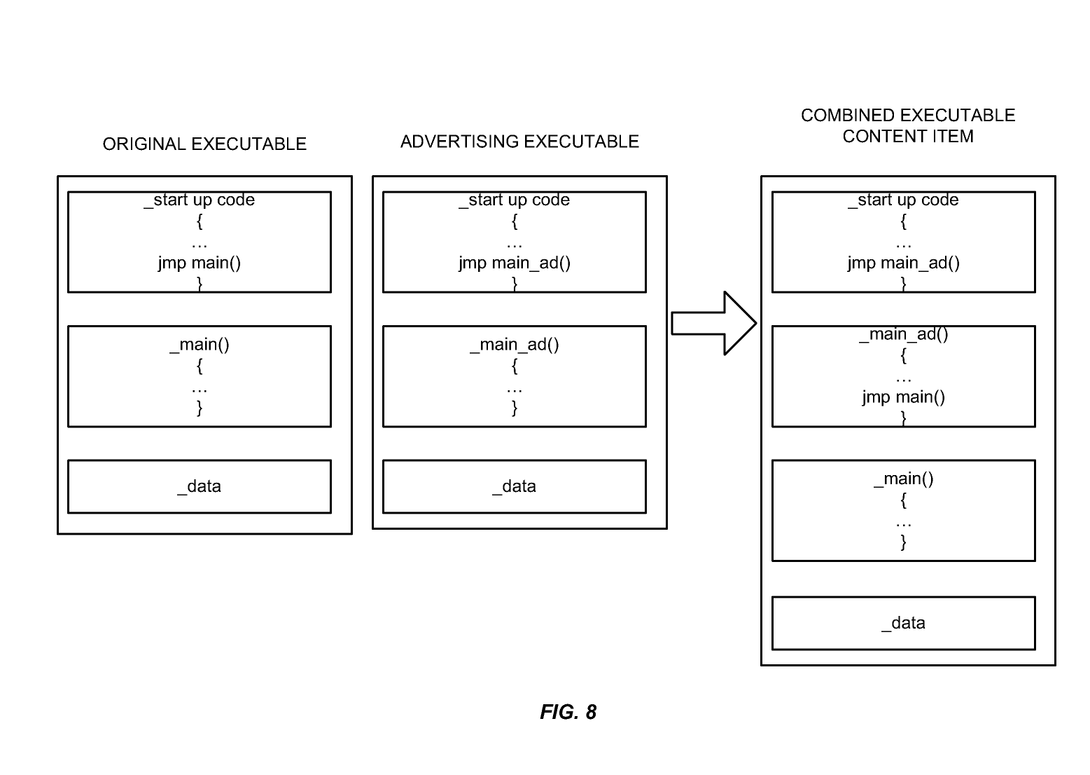

Referring to FIG. 8, which shows sample code before and after an appending step, a user may download an executable file for later use. When the file is requested, the server side selects an additional executable, which will be attached to the desired executable. When run, the advertising executable will start first, execute, and then execute the desired executable. Optionally, the wrapping executable may search for additional updated advertising content when run rather than relying on the originally attached content.

### EXAMPLE 4

An HDi application is downloaded from an online service for use on an HD-DVD player or other device. When requested, the HDi application is modified to provide a selected advertisement wrapper for the application.

The above describes various arrangements for dynamically attaching advertisements to requested content items. The below describes aspects that are generally common to the various arrangements.

While the “second content item” has been disclosed primarily in the form of an advertisement, it may be any digital media item, such as an audio, video, or other such content item file. Moreover, while the same has been termed to be “associated” with the first content, no similarity or pertinence need be present.

While the advertising content item repository, content item repository, and association module have been disclosed as separate modules, the same may be physically disposed in any combination. For example, each may reside on separate servers, each may reside on the same server, or certain modules may share a server while others are on a different server. Where modules reside on separate servers, the same may communicate via signal transmission over any wired or wireless network, including the internet and optical communications schemes. The modules may be implemented in hardware, software, or in a combination of hardware and software.

While the content items have been generally disclosed as being downloaded from a server to a client, the same may be streamed rather than downloaded. Moreover, content items need not be completely downloaded prior to being played back; rather, the same need only be partially downloaded and thus capable of being played back prior to initiation of playback.

Any number of expert systems, neural networks, Bayesian networks, and the like, maybe employed to analyze the user's purchase patterns, preferences, or other behavioral patterns in order to direct advertising content that is most pertinent, i.e., personalized, to that user. Advertising placement, retrieval and time of playback (relative to the requested content item playback) may be used to optimize the effect of the advertising on the viewer, and determination of the same may be implemented on the client side or on the server side.

While the arrangements described have in large part discussed downloading of an original advertisement, the same may be employed to download a modification to an existing advertisement. For example, the same may be employed to download an executable file that modifies the price or other details of a previously-downloaded advertisement for a product. In this way, the bandwidth needed for a follow-on advertisement may be lessened.

Thus, it can be seen that the arrangements described enable a convenient way to dynamically combine advertisements or other content with requested content items.

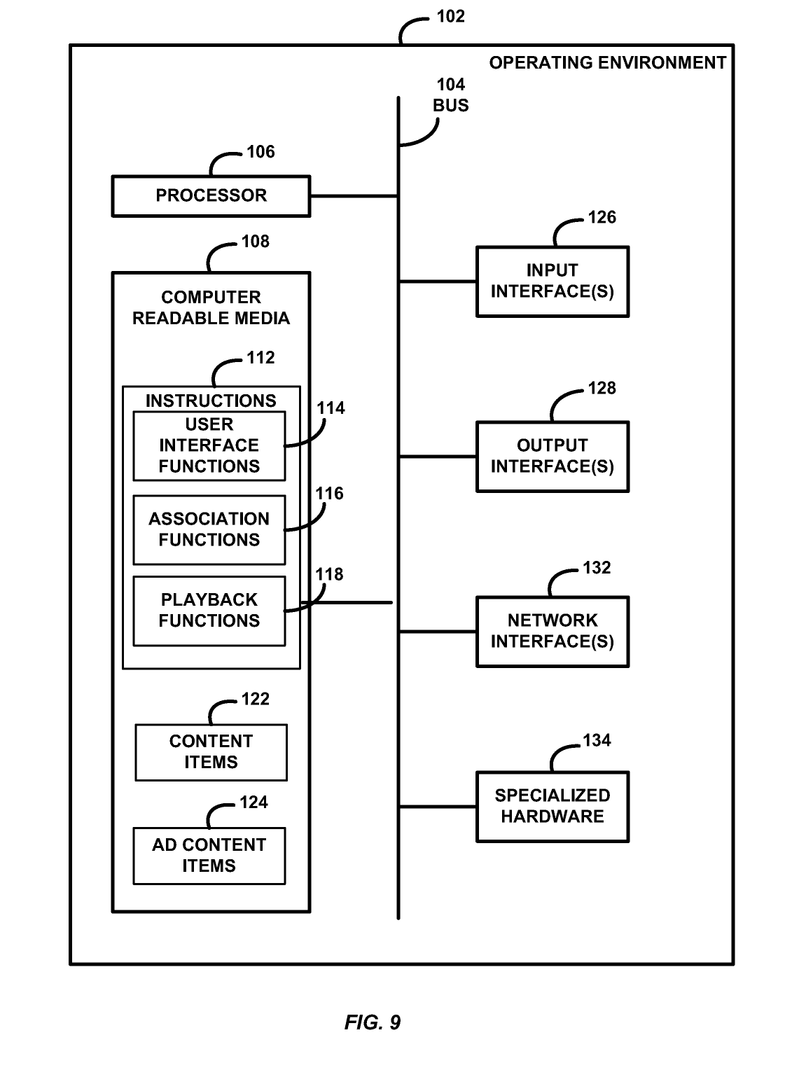

FIG. 9 is a block diagram of an exemplary configuration of an operating environment 102 (such as a client-side device or application or a networked server or service) in which all or part of the methods shown and discussed in connection with the figures may be implemented or used. Operating environment 102 is generally indicative of a wide variety of general-purpose or special-purpose computing environments, and is not intended to suggest any limitation as to the scope of use or functionality of the arrangements described herein.

As shown, operating environment 102 includes processor 106, computer-readable media 108, and computer-executable instructions 112. One or more internal buses 104 may be used to carry data, addresses, control signals, and other information within, to, or from operating environment 102 or elements thereof.

Processor 106, which may be a real or a virtual processor, controls functions of the operating environment by executing computer-executable instructions 112. The processor may execute instructions at the assembly, compiled, or machine-level to perform a particular process.

Computer-readable media 108 may represent any number and combination of local or remote devices, in any form, now known or later developed, capable of recording, storing, or transmitting computer-readable data, such as the above-noted computer-executable instructions 112, including user interface functions 114, association functions 116 for the association module, playback functions 118 for the player, content items 122, and advertising content items 124. In particular, the computer-readable media 108 may be, or may include, a semiconductor memory (such as a read only memory (“ROM”), any type of programmable ROM (“PROM”), a random access memory (“RAM”), or a flash memory, for example); a magnetic storage device (such as a floppy disk drive, a hard disk drive, a magnetic drum, a magnetic tape, or a magneto-optical disk); an optical storage device (such as any type of compact disk or digital versatile disk); a bubble memory; a cache memory; a core memory; a holographic memory; a memory stick; a paper tape; a punch card; or any combination thereof. The computer-readable media may also include transmission media and data associated therewith. Examples of transmission media/data include, but are not limited to, data embodied in any form of wireline or wireless transmission, such as packetized or non-packetized data carried by a modulated carrier signal.

Computer-executable instructions 112 represent any signal processing methods or stored instructions. Generally, computer-executable instructions 112 are implemented as software components according to well-known practices for component-based software development, and encoded in computer-readable media. Computer programs may be combined or distributed in various ways. Computer-executable instructions 112, however, are not limited to implementation by any specific embodiments of computer programs, and in other instances may be implemented by, or executed in, hardware, software, firmware, or any combination thereof. That is, the arrangement need not be implemented in a computer program per-se, but may in fact be burned into firmware on single-purpose processors in CE-type devices.

Input interface(s) 126 are any now known or later developed physical or logical elements that facilitate receipt of input to operating environment 102.

Output interface(s) 128 are any now known or later developed physical or logical elements that facilitate provisioning of output from operating environment 102.

Network interface(s) 132 represent one or more physical or logical elements, such as connectivity devices or computer-executable instructions, which enable communication between operating environment 102 and external devices or services, via one or more protocols or techniques. Such communication may be, but is not necessarily, client-server type communication or peer-to-peer communication. Information received at a given network interface may traverse one or more layers of a communication protocol stack.

Specialized hardware 134 represents any hardware or firmware that implements functions of operating environment 102. Examples of specialized hardware include encoder/decoders decrypters, application-specific integrated circuits, clocks, and the like.

The methods shown and described above may be implemented in one or more general, multi-purpose, or single-purpose processors. Unless specifically stated, the methods described herein are not constrained to a particular order or sequence. In addition, some of the described methods or elements thereof can occur or be performed concurrently.

It if further noted that the arrangements and methods shown may also be situated and designed in a mobile or portable environment, such as ones employing lower power chipsets, distributed chipsets, and chips that are single-purpose, as opposed to general purpose processors.

Functions/components described herein as being computer programs are not limited to implementation by any specific embodiments of computer programs. Rather, such functions/components are processes that convey or transform data, and may generally be implemented by, or executed in, hardware, software, firmware, or any combination thereof.

It will be appreciated that particular configurations of the operating environment may include fewer, more, or different components or functions than those described. In addition, functional components of the operating environment may be implemented by one or more devices, which are co-located or remotely located, in a variety of ways.

Although the subject matter herein has been described in language specific to structural features and/or methodological acts, it is also to be understood that the subject matter defined in the claims is not necessarily limited to the specific features or acts described above. Rather, the specific features and acts described above are disclosed as example forms of implementing the claims.

It will further be understood that when one element is indicated as being responsive (or the like) to another element, the elements may be directly or indirectly coupled. Connections depicted herein may be logical or physical in practice to achieve a coupling or communicative interface between elements. Connections may be implemented, among other ways, as inter-process communications among software processes, or inter-machine communications among networked computers.

The word “exemplary” is used herein to mean serving as an example, instance, or illustration. Any implementation or aspect thereof described herein as “exemplary” is not necessarily to be constructed as preferred or advantageous over other implementations or aspects thereof

As it is understood that embodiments other than the specific embodiments described above may be devised without departing from the spirit and scope of the appended claims, it is intended that the scope of the subject matter herein will be governed by the following claims.

1. A method of delivering a first content item along with a second content item, comprising:
a. receiving a request for a first content item from a client;
b. associating a second content item with the first content item; and
c. downloading the first content item and the second content item to the client.

2. The method of claim 1, in which the first and second content items are downloaded at the same time.

3. The method of claim 1, in which the first and second content items are downloaded at different times.

4. The method of claim 1, further comprising appending the second content item to the first content item.

5. The method of claim 4, in which the appending is performed at the client.

6. The method of claim 1, further comprising downloading a plurality of second content items, caching the plurality of second content items, and wherein the associating step associates a second content item from the cache with the first content item.

7. The method of claim 4, in which the appending is performed at a server.

8. The method of claim 1, further comprising reformatting either the first or the second content item to match the format of the other content item.

9. A method of downloading a first content item and a second content item for playback, comprising:
a. receiving a request at a server from a client for a first content item;
b. downloading the first content item and a second content item from the server to the client;
c. such that when the first content item is played back, the second content item is played back along with the first content item.

10. The method of claim 8, in which the second content item is an advertisement.

11. The method of claim 8, in which the first content item is a media file.

12. The method of claim 8, further comprising reformatting the first or second content item to match a format of the other.

13. The method of claim 12, further comprising appending either the first or second content item to the other.

14. The method of claim 8, in which when the first and second content items are played back, the client is not in signal communication with the server.

15. Upon loading a first content item into a content player, a method of enabling playback of a second content item, comprising:
a. receiving a notification at a server that a first content item has been downloaded, loaded in a player, or that a trigger content item has been played or loaded;
b. upon receipt of the notification, downloading a second content item to the client;
c. such that when the first content item or trigger content item is played back, the second content item is played back just prior to, during, or just subsequent to the first content item or the trigger content item.

16. The method of claim 15, in which the loading includes loading a CD or DVD into a CD or DVD player, respectively.

17. The method of claim 15, in which the loading includes loading a media file into a computer memory.

18. The method of claim 15, further comprising reformatting the second content item to match the format of the first content item or the trigger content item.

19. The method of claim 18, further comprising appending either the first, trigger, or second content item to the other.

20. The method of claim 19, in which the appending is performed at the client using HDi extensions.
